(19) United States
(12) Patent Application Publication
(10) Pub. No.: US 2020/0079152 A1
(43) Pub. Date: Mar. 12, 2020

(54) FREEWHEELING HUB SYSTEM

(71) Applicant: Christianson Systems, Inc., Blomkest, MN (US)

(72) Inventors: Jim Gerhardt, St. Augusta, MN (US); Shannon Hansen, Bird Island, MN (US); Daniel Orellana, St. Cloud, MN (US)

(73) Assignee: Christianson Systems, Inc., Blomkest, MN (US)

(21) Appl. No.: 16/567,963

(22) Filed: Sep. 11, 2019

Related U.S. Application Data
(60) Provisional application No. 62/829,372, filed on Apr. 4, 2019.
(60) Provisional application No. 62/730,418, filed on Sep. 12, 2018.

(51) Int. Cl. B60B 27/04; B60B 27/02; F16D 41/07; F16D 41/28

(52) U.S. Cl. CPC B60B 27/047; F16D 41/28; F16D 41/07; B60B 27/023

(57) ABSTRACT

A sprag clutch based freehub system that has an easily swappable free hub portion is provided. The freehub system uses a cassette driver adapter shaft (also referred herein as “driver”) that is positioned within the hub. The cassette driver adapter shaft (driver) and freehub body have a separable interface. This allows for easy interchanging of freehub bodies by the user while not risking contamination or damage to the hub.

### CROSS-REFERENCE TO RELATED APPLICATIONS

This application claims priority to U.S. Provisional Application Ser. No. 62/829,372 filed on Apr. 4, 2019; and 62/730,418 filed on Sep. 12, 2018, the entire contents of which are hereby expressly incorporated herein by reference.

### BACKGROUND

Freewheeling hubs (freehubs) enable the rotation of the bicycle pedals to drive the rotation of the wheels while also allowing the wheels to rotate independently of the rotation of the pedals. Freewheeling hubs enable the pedals of the bicycle to be held stationary while the wheels rotate as the bicycle coasts.

Freewheeling hubs include cassette drivers that include a free hub portion that supports the cassette and a driver portion that transmits torque from the cassette to the main hub body. U.S. Patent Publication Nos. 2017/0284481 and 2017/0284482 directed to cassette drivers are both hereby incorporated by reference in their entirety. These cassette drivers can be used with state of the art sprag clutch based freewheeling hubs such as that shown and described in U.S. Pat. No. 9,102,197, which is hereby incorporated by reference in its entirety. However, swapping one cassette driver for another requires performing a number of steps. There is a need in the art to provide state of the art sprag based hubs that have freehubs that are easily swappable for another.

### SUMMARY

The present disclosure provides a sprag clutch based freehub system that has an easily swappable free hub portion. The freehub system of the present disclosure uses a cassette driver adapter shaft (also referred herein as “driver”) that is positioned within the hub. The adapter shaft (driver) and freehub body have a separable interface. This allows for easy interchanging of freehub bodies by the user while not risking contamination or damage to the hub.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a perspective view of a hub according to one example of the present disclosure.

FIG. 2 is an exploded assembly view of the hub of FIG. 1.

FIG. 3 is an isometric, longitudinal cross-sectional view of the hub of FIG. 1.

FIG. 4 is a side, longitudinal cross-sectional view of the hub of FIG. 1.

FIG. 5 is a partially exploded assembly view of the hub of FIG. 1.

FIG. 6 is a cross-sectional view of a mating interface along line 5-5 of FIG. 4.

FIGS. 7-11 show a hub according to another example of the present disclosure.

FIG. 12 shows an exploded view of the hub of FIG. 7.

FIG. 13 is a cross-sectional view of the hub along line A-A of FIG. 10.

FIG. 14 is a cross-sectional view of the hub along line B-B of FIG. 10.

FIG. 15 is a perspective view of the cross section of FIG. 15.

FIG. 16 is a cross-sectional view of the hub along line C-C of FIG. 14.

FIGS. 17-19 show an axle of the hub of FIG. 7.

FIGS. 20-24 show an adapter shaft of a freehub drive system of the hub of FIG. 7.

FIGS. 25-28 show a freehub body of a freehub drive system of the hub of FIG. 7.

FIGS. 29-32 show a sprag sleeve of a sprag clutch of the hub of FIG. 7.

FIG. 33 is a partially exploded assembly view of the hub of FIG. 7.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

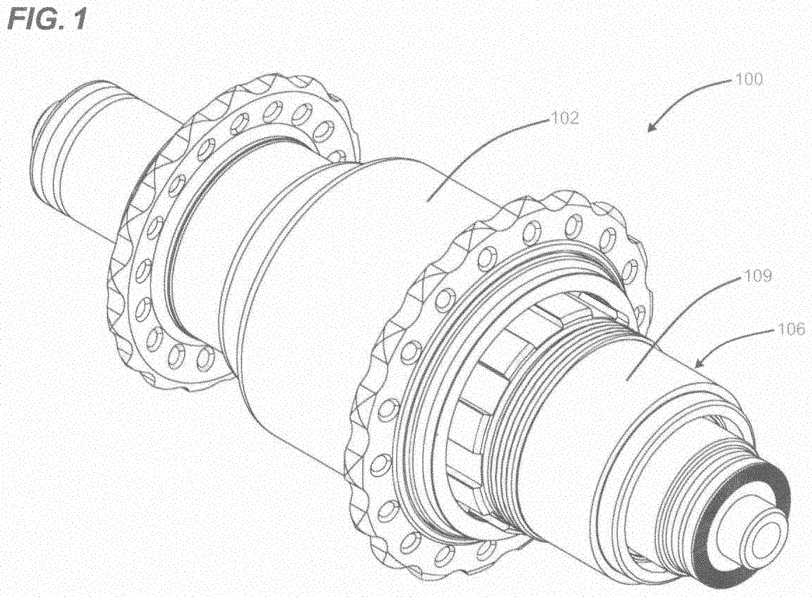

Referring to FIG. 1, a first embodiment of a hub 100 according to the present disclosure is shown. In the depicted embodiment, the hub 100 includes a hub body 102, an axle 105, and a freehub body 106. In the depicted embodiment, the hub 100 is configured to freewheel. In other words, a freehub body 106 rotates with the hub body 102 when the wheel is driven by the freehub body 106, and the freehub body 106 rotates relative to the hub body 102 when the wheel is coasting (rotating and not being driven).

Referring to the FIGS. generally, the configuration of hub 100 is described in greater detail. In the depicted embodiment, the hub 100 is configured for use with single speed as well as multiple speed bicycles (e.g., road bikes, mountain bikes, etc.) that utilize an external cassette driven by a chain. In the depicted embodiment, the hub 100 utilizes a sprag clutch 108 to facilitate freewheeling. It should be appreciated that the principles of the present disclosure can be integrated into a single speed bicycle. It should be appreciated that the principles of the present disclosure have applicability in a number of different contexts. For example, the present disclosure has applicability to hubs that are belt driven or shaft driven in addition to chain driven hubs. Many other embodiments are possible.

The hub body 102 can have a necked down configuration to reduce the overall weight of the hub body 102.

The freehub body 106 has an outer surface 109 that is configured to receive a cassette (not shown). The outer surface 109 can have a variety of different configurations (e.g., standards) to receive a variety of different configurations of cassettes.

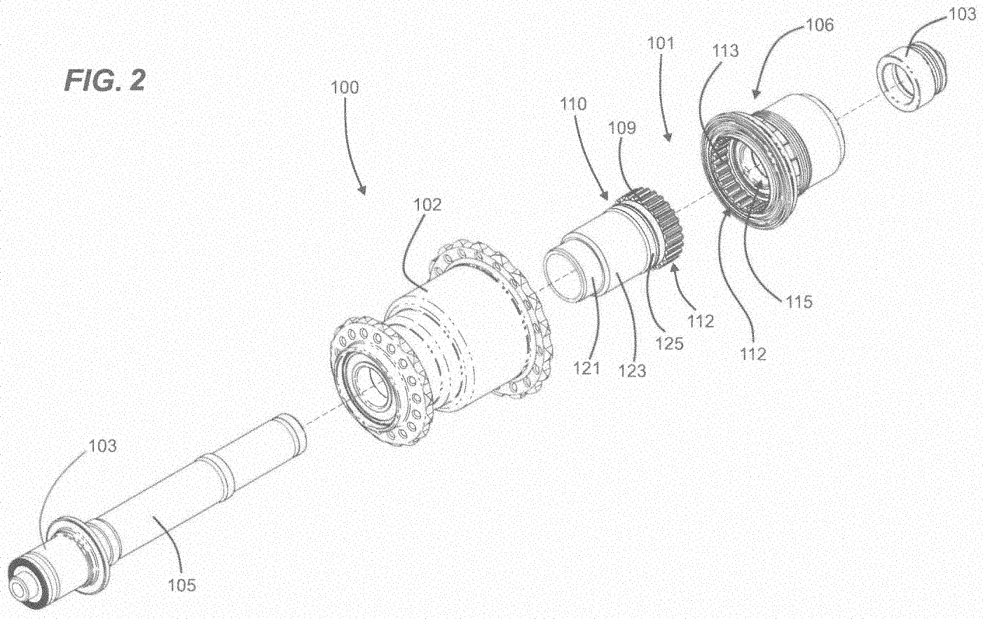

FIG. 2 shows a partially exploded view of the hub 100. As shown, a freehub drive system 101 is shown to include an adapter shaft 110 and the freehub body 106. The freehub body 106 mates to the adapter shaft 110 via a mating interface 112 and is held onto the hub body 102 via a cap 103. The mating interface 112 allows for the freehub body 106 to rotate, in both directions, with the adapter shaft 110. The mating interface 112 prevents relative rotational movement between the adapter shaft 110 and the freehub body 106.

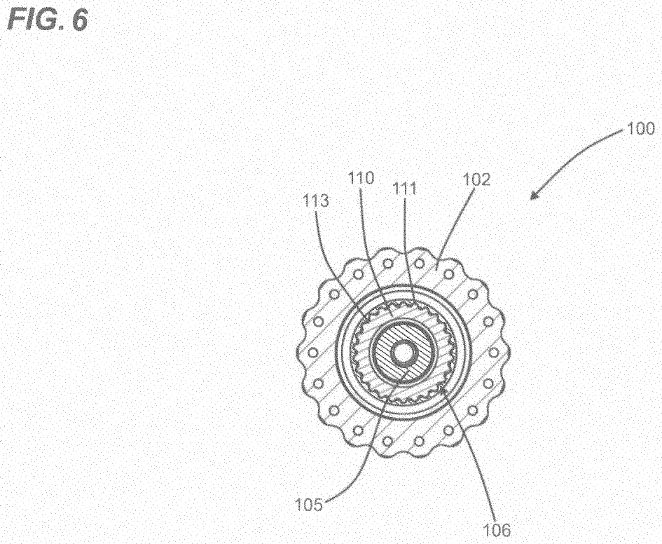

As shown, the adapter shaft 110 further includes a plurality of cylindrical outer surfaces 121, 123, 125. Further, the adapter shaft 110 includes a set of adapter shaft splines 111, and the freehub body 106 includes a set of freehub body splines 113 within a recess 115. The adapter shaft splines 111 (FIG. 6) and the freehub body splines 113 are configured to mesh with one another to create the mating interface 112. It is considered within the scope of the present disclosure that the amount of splines on either the adapter shaft 110 or freehub body 106 can differ. In some examples, the adapter shaft 110 and freehub body 106 can have differing numbers of splines. In some examples, the adapter shaft 110 and freehub body 106 can have an equal number of splines. It is considered within the scope of the present disclosure that a variety of other mating surfaces having a variety of different configurations can be utilized to mate the adapter shaft 110 and the freehub body 106 to create the mating interface 112.

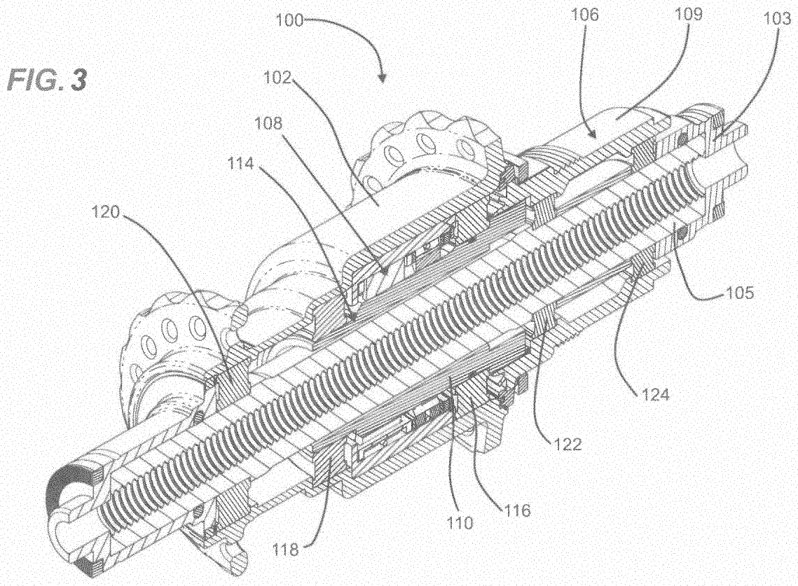

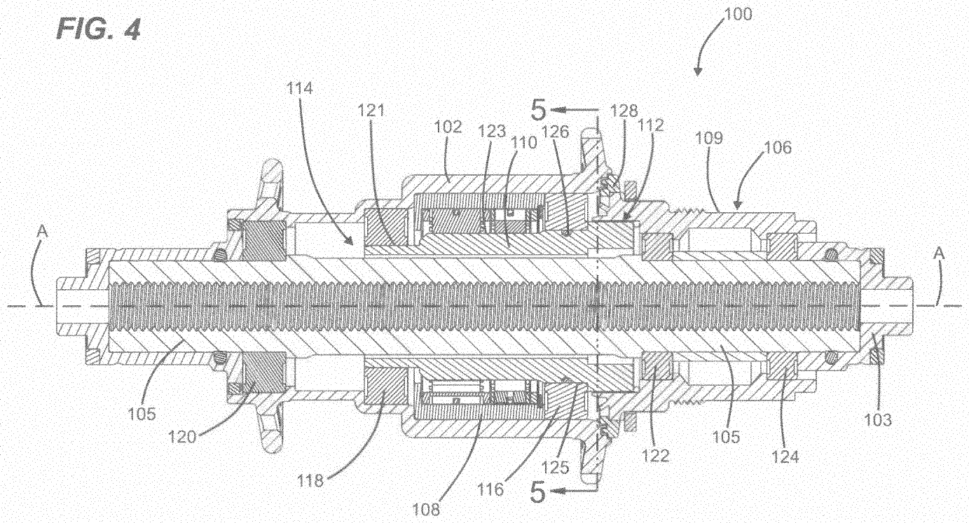

FIGS. 3 and 4 show a cross section of the hub 100. As shown, the adapter shaft 110 is received in an internal cavity 104 of the body 102, and positioned around the axle 105. The internal cavity 104 is shown to include the sprag clutch 108, a first bearing set 116, a second bearing set 118, and a third bearing set 120. The axle 105 is rotationally supported by the third bearing set 120 and by a first and a second freehub body bearing set 122, 124, each being positioned within the freehub body 106. The adapter shaft 110 is supported on either end by the first bearing set 116 and the second bearing set 118. The adapter shaft 110 is also in contact with the sprag clutch 108, so that, upon rotation of the adapter shaft 110 in a first direction (i.e., during pedaling), the adapter shaft 110 transfers rotational force through the sprag clutch 108 to the hub body 102, thereby driving the wheel. The adapter shaft 110 defines a longitudinal axis of rotation that is coaxial and coincident with an axis of rotation A-A of the hub body 102.

The plurality of cylindrical outer surfaces 121, 123, 125 of the adapter shaft 110 are shown mating with components positioned within the internal cavity 104 of the hub body 102. The first cylindrical surface 121 interfaces between the adapter shaft 110 and the second bearing set 118. The second cylindrical surface 123 has a larger diameter than the first cylindrical surface 121 and extends toward the adapter shaft splines 111. The second cylindrical surface 123 is configured to interface with the sprag clutch 108. In some examples, the surface finish of the second cylindrical surface 123 is less than or equal to Rz of 2.5 micrometers and has a HRC hardness of at least 56 (e.g., between 58 to 62). In some embodiments, the second cylindrical surface 123 is constructed of stainless steel. The third cylindrical surface 125 extends coaxially from the second cylindrical surface 123 towards the adapter shaft splines 111. The third cylindrical surface 125 has a diameter that is greater than the diameter of the second cylindrical surface 123. The third cylindrical surface 125 interfaces with the first bearing set 116. It should be appreciated that many alternative constructions are possible. For example, different material can be used in place of stainless steel and the material used can have different hardness characteristics other than the example hardness values identified above.

The hub 100 can also include a variety of seals to prevent contaminates (e.g., water and sediment) from entering the internal cavity 104 of the hub body 102. In some examples, the adapter shaft 110 can include an adapter shaft seal 126 (FIG. 4) to seal between the adapter shaft 110 and the first bearing set 116. In some examples, the adapter shaft seal 126 is a rubber O-ring. In some examples, the freehub body 106 can include a freehub body seal 128 to seal where the freehub body 106 abuts the hub body 102. In some examples, the freehub body seal 128 can be a labyrinth seal. In some examples, the freehub body seal 128 can be a rubber seal.

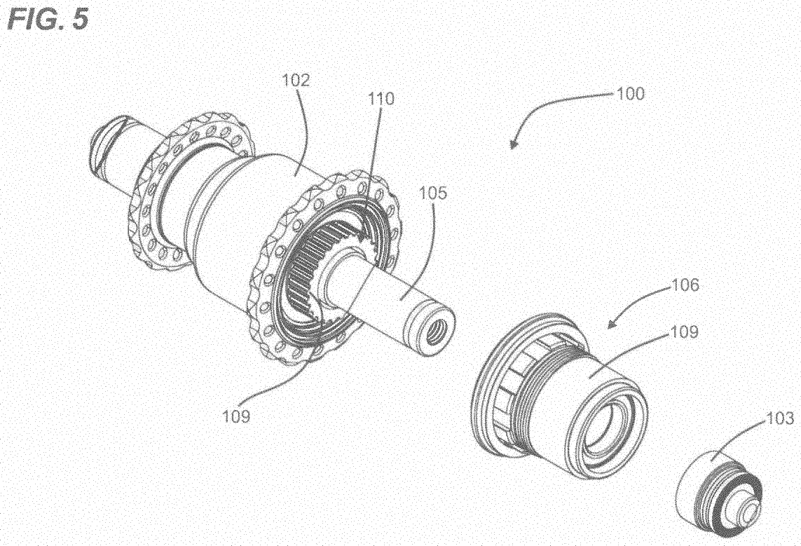

FIG. 5 shows the freehub body 106 and cap 103 removed from the hub 100, while the adapter shaft 110 remains installed within the hub body 102. The depiction of FIG. 5 is an example scenario that a user will encounter when interchanging freehub bodies from the hub 100. A user may want to interchange freehub bodies due to wear on the freehub body 106 and/or a desire to change freehub body standards, among other reasons. When changing out the freehub body 106, the user removes the cap 103 from the axle 105, then separates the freehub body 106 from the hub body 102. At this time, the internal cavity 104 remains sealed given the positioning of the adapter shaft 110 within the internal cavity 104. This reduces the chances of contaminants being introduced into the internal cavity 104, which could otherwise reduce the performance of the hub 100, specifically the sprag clutch 108. Further, by maintaining the adapter shaft 110 within the internal cavity 104 during a freehub body interchange, damage to any component that is positioned within the internal cavity 104 is reduced. Specifically, damage to the sprag clutch 108 and/or bearing sets 116, 118, 120 can be reduced by limiting access to such components.

FIG. 6. shows a cross-sectional view along line 5-5 in FIG. 4, which shows the mating interface 112. As shown, the adapter shaft splines 111 are meshed together with the freehub body splines 113 to form the mating interface 112 so that the adapter shaft 110 and freehub body 106 rotate with one another.

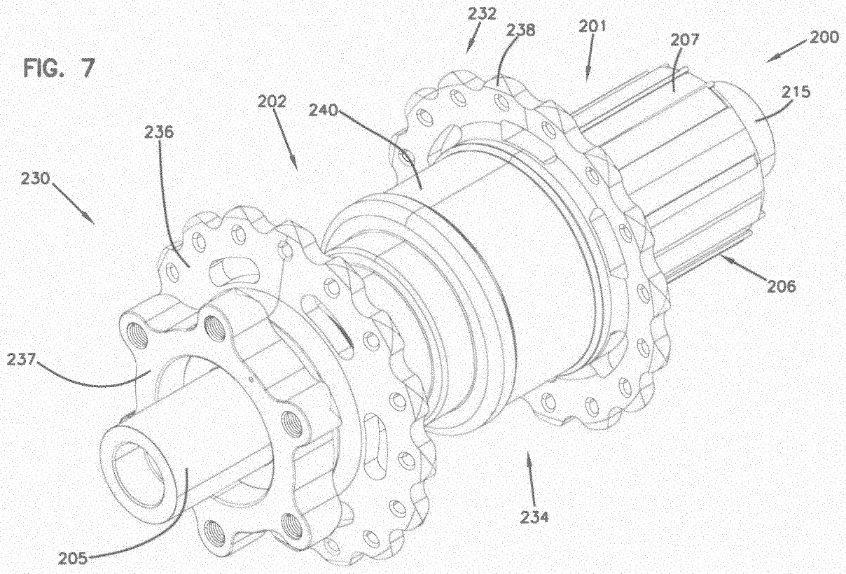

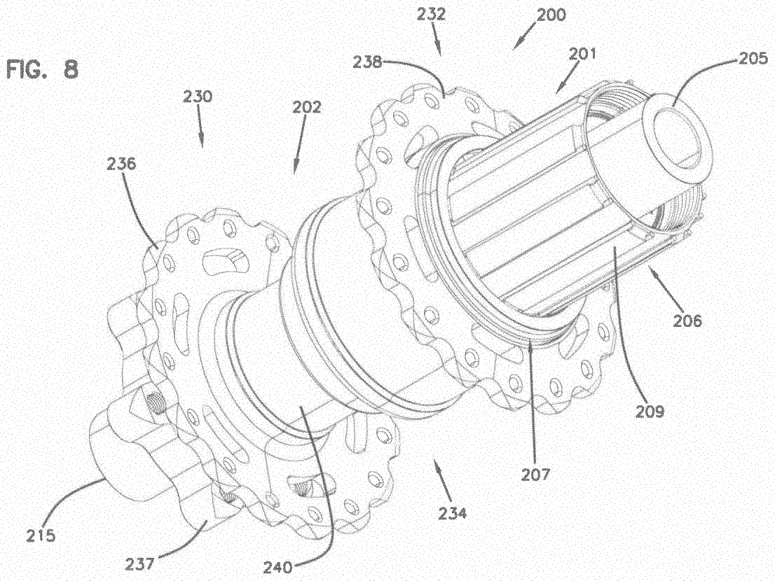

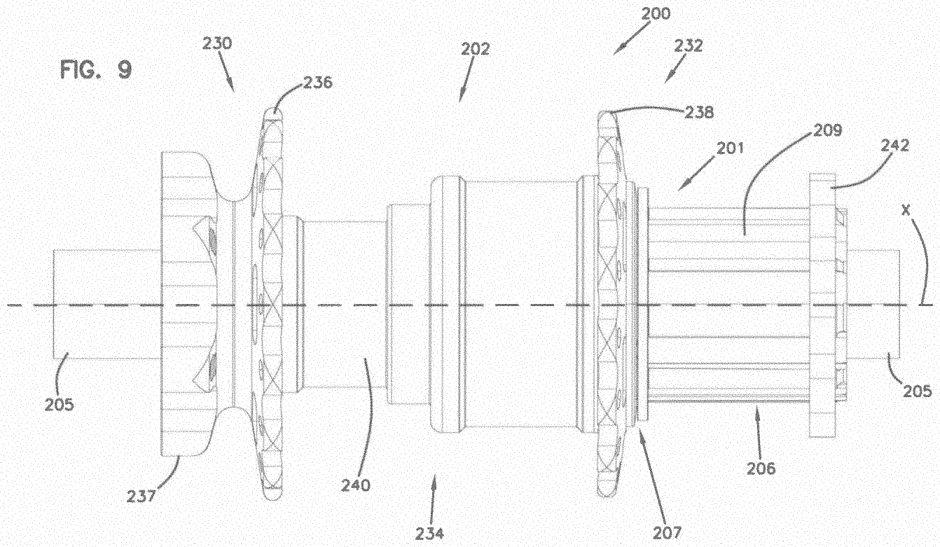

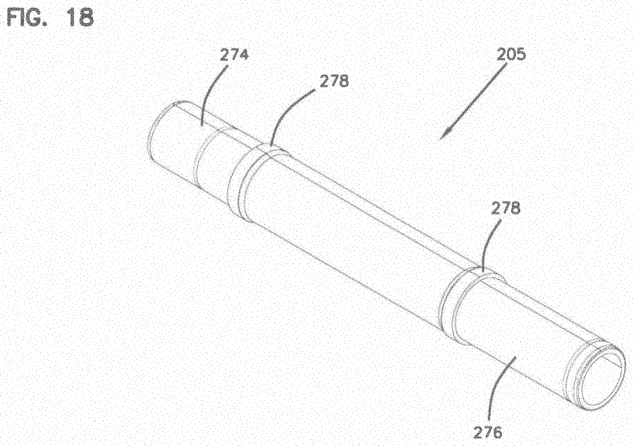

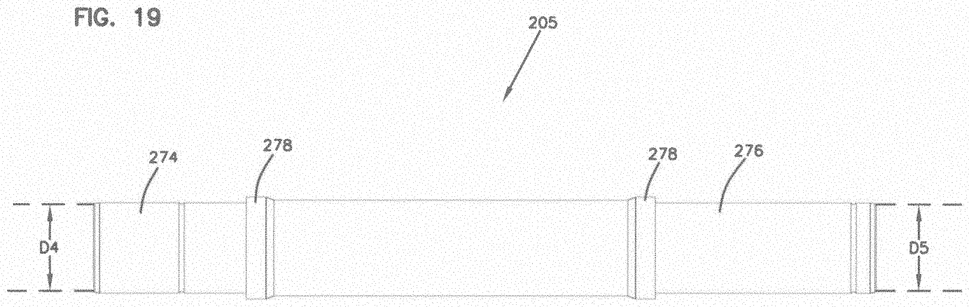

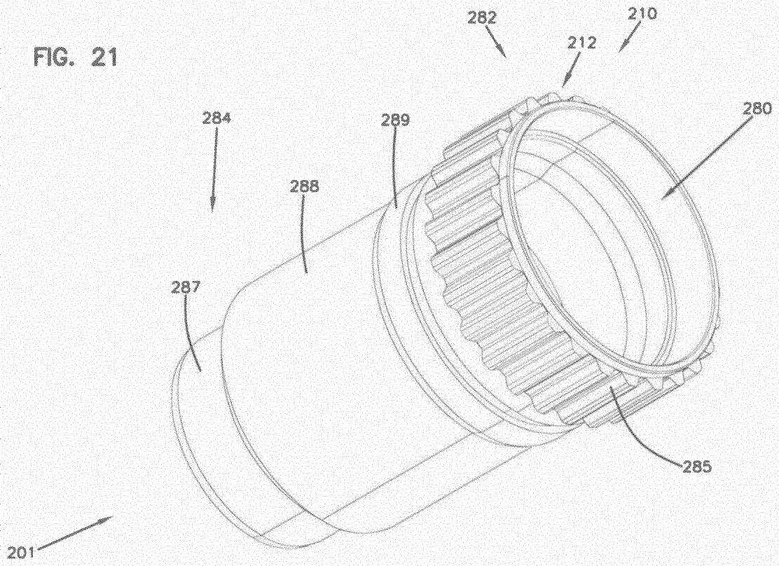

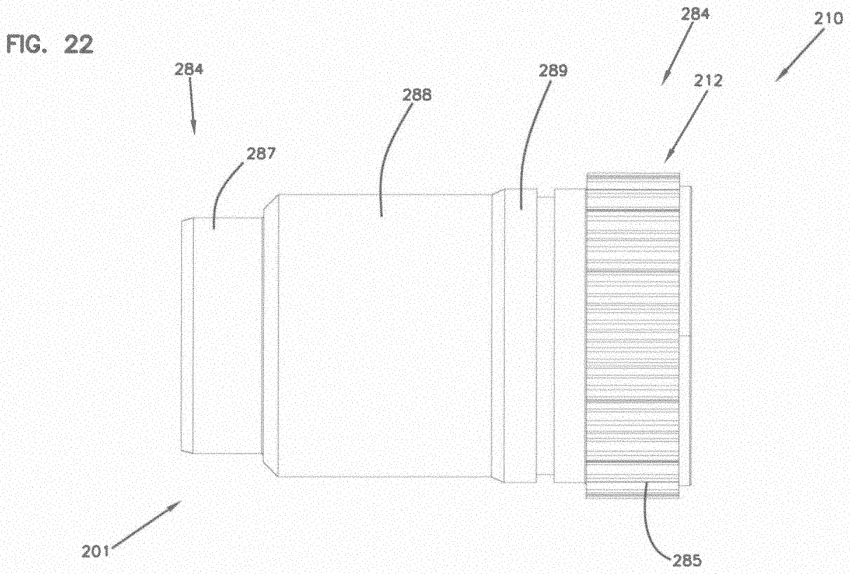

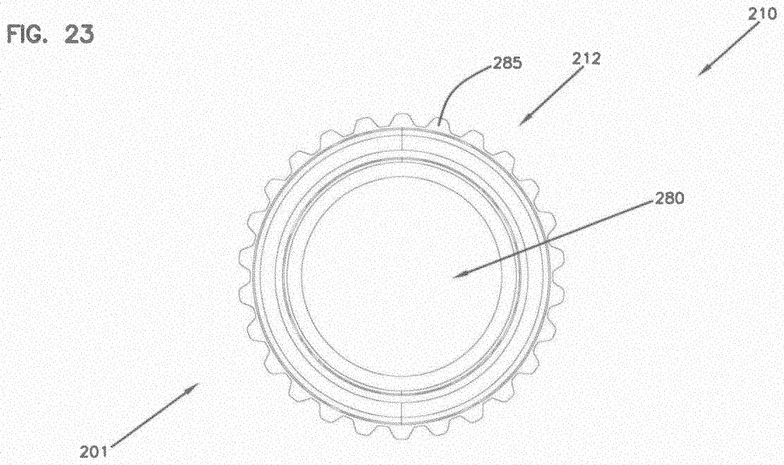

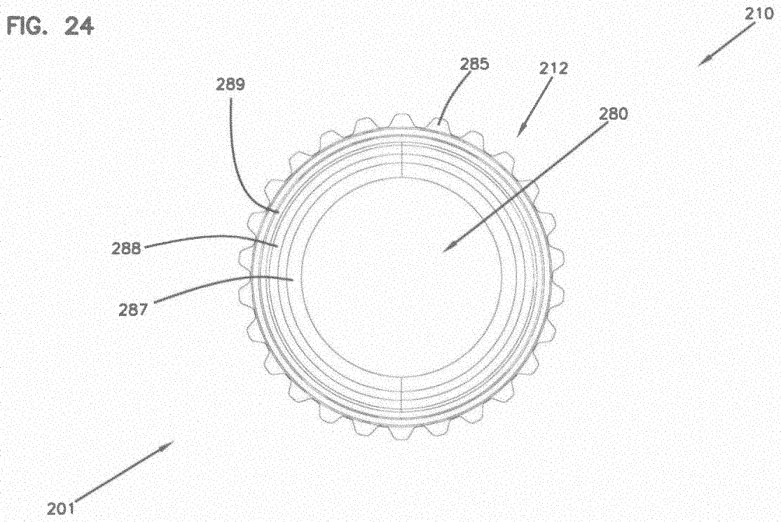

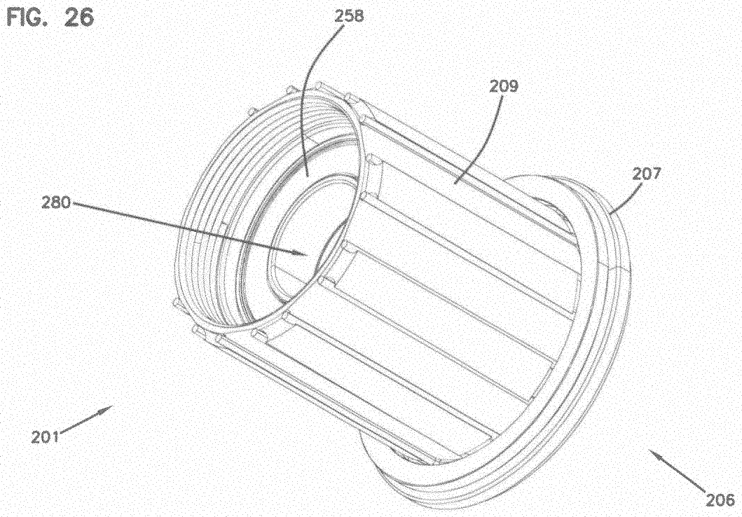

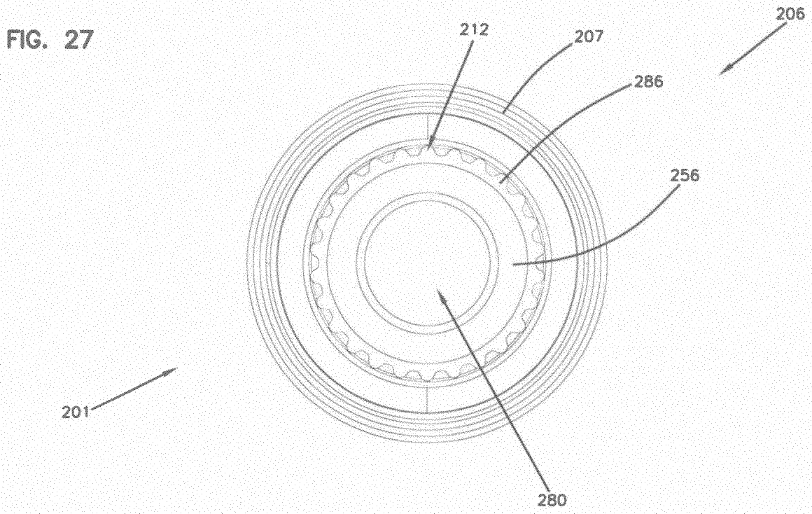

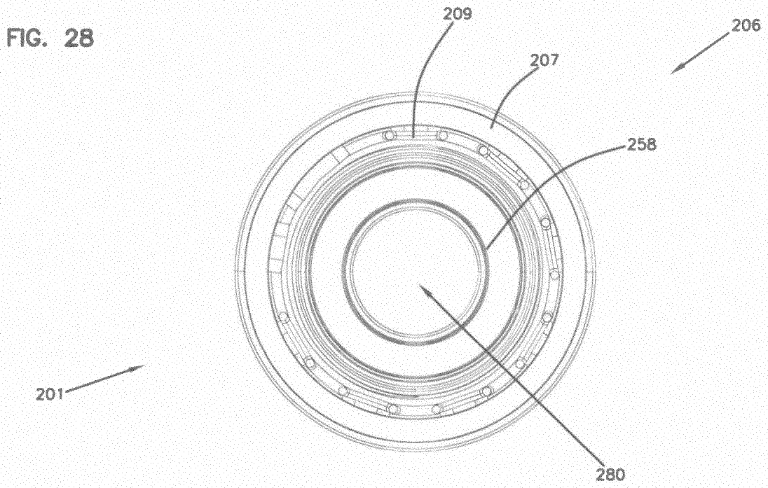

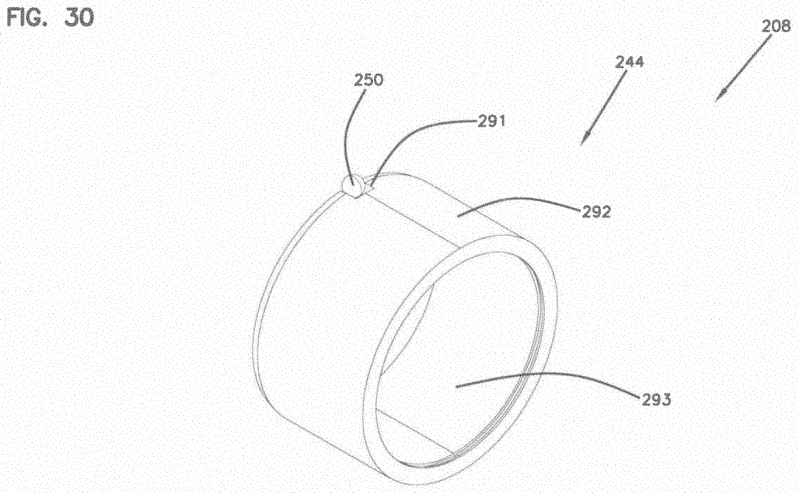

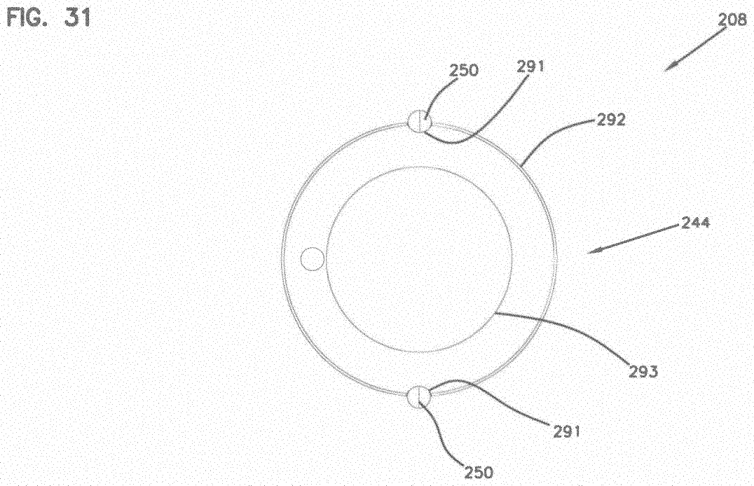

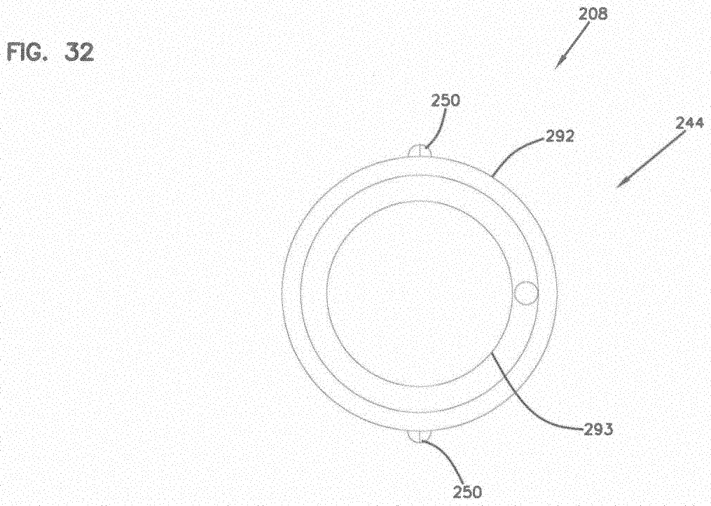

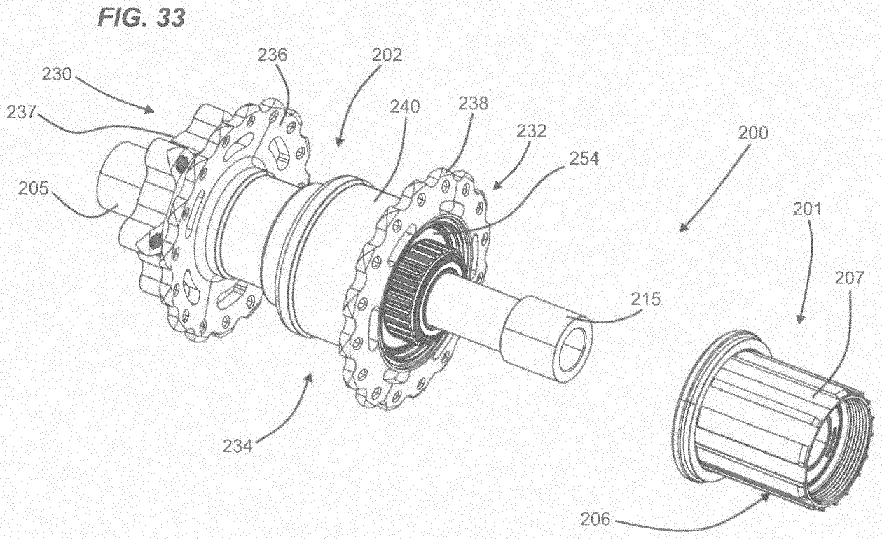

FIGS. 7-33 show another example of a hub 200, according to another example of the present disclosure. The hub 200 is substantially similar to the hub 100, described above. Like hub 100 above, hub 200 is a rear hub for a bicycle. The hub 200 includes a freehub drive system 201, a hub body 202, and an axle 205. It should be appreciated that the principles of the present disclosure have applicability beyond bicycle hubs. The principles can be applied to any type of rotational power transmission system.

The hub body 202 is substantially similar to the hub body 102, described above. The hub body 202 includes a first end 230 and a second end 232. In the depicted examples, the second end 232 is configured to receive the freehub drive system 201. The hub body 202 can have a stepped configuration to reduce the overall weight of the hub body 202. In some examples, the hub body 202 is constructed from aluminum.

The hub body 202 defines longitudinal rotational axis X around which the hub body 202 is rotatable. The hub body 202 includes an external surface 234 that defines a first radially extending spoke support flange 236 located at the first end 230 of the hub body 202 and a second radially extending spoke support flange 238 located at the second end 232 of the hub body 202. Both the first radially extending spoke support flange 236 and the second radially extending spoke support flange 238 are configured to receive spokes of a bicycle wheel. In some examples, the hub body 202 includes a disc brake flange 237 at the first end 230. The disc brake flange 237 is configured to receive a disc rotor for use with disc brakes. It should be appreciated that many alternative configurations are possible. For example, the hub body 202 could be integral with the wheel as a full carbon disk wheel. Alternatively, the hub body 202 could be part of a power transmission outside of the bicycle context (e.g., ATV, motorcycle, etc.).

The hub body 202 also includes a stepped body portion 240 that extends between the first and second spoke support flanges 236, 238. In some examples, the stepped body portion 240 can have a stepped configuration where the stepped body portion 240 includes a plurality of surfaces that each have a plurality of different diameters. It is considered within the scope of the present disclosure that the hub body 202 can have a variety of different shapes and sizes. In some examples, the stepped configuration allows for a reduction in the overall weight of the hub body 202 while still maintaining sufficient strength and durability.

The freehub drive system 201 is substantially similar to the freehub drive system 101, described above. The freehub drive system 201 is received at the second end 232 of the hub body 202 and includes a freehub body 206 that is connected to the hub body 202. In some examples, the freehub body 206 includes a seal 207 to prevent contaminants from entering the hub body 202 when the freehub body 206 is installed on the second end 232 of the hub body 202.

The freehub body 206 is substantially similar to the freehub body 106, described above. The freehub body 206 has an outer surface 209 that is configured to receive at least one sprocket 242. In some examples, a cassette (not shown) including a plurality of sprockets 242 can be mounted to the outer surface 209. In other examples, a single sprocket 242 can be mounted to the outer surface 209. In some examples, the sprockets 242 on the outer surface 209 are configured to receive a chain. In other examples, the sprockets 242 on the outer surface 209 are configured to receive a belt. Like the outer surface 109 described above, the outer surface 209 can have a variety of different configurations (e.g., standards) to receive a variety of different configurations of sprockets 242.

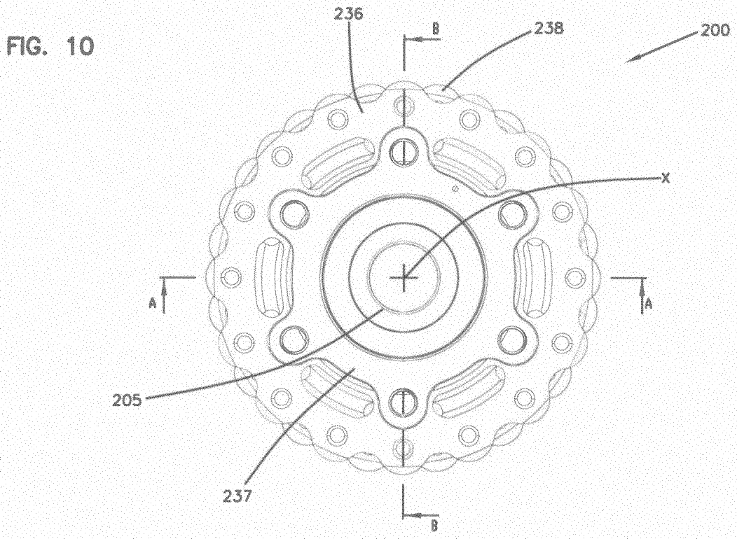

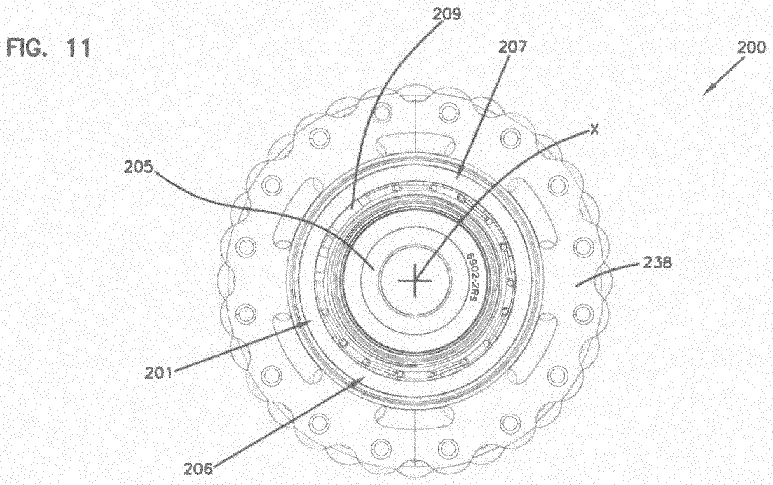

FIG. 10 shows an end view of the hub 200 from the first end 230. FIG. 11 shows an end view of the hub 200 from the second end 232.

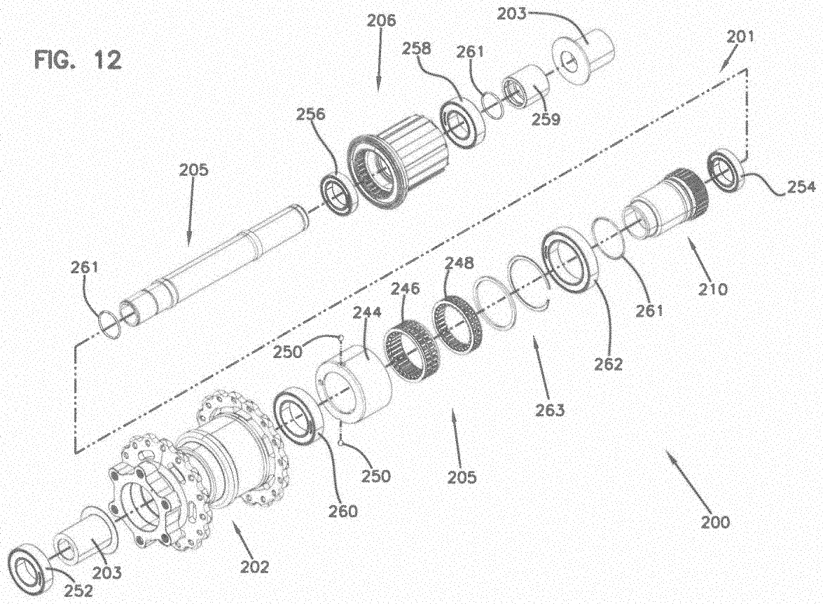

FIG. 12 shows an exploded view of the hub 200. The hub 200 includes the freehub drive system 201 that includes the freehub body 206 and an adapter shaft 210; the hub body 202; a pair of end caps 203 configured to fit over, and act as part of, the axle 205; a sprag clutch 208 including a sprag sleeve 244, a first sprag cage 246, and a second sprag cage 248; a pair of sprag sleeve anti-rotation elements 250; a first axle bearing 252; a second axle bearing 254; a third axle bearing 256; a fourth axle bearing 258; a freehub spacer 259; a first freehub drive system bearing 260; a second freehub drive system bearing 262; O-rings 261; and a sprag clutch retaining ring assembly 263.

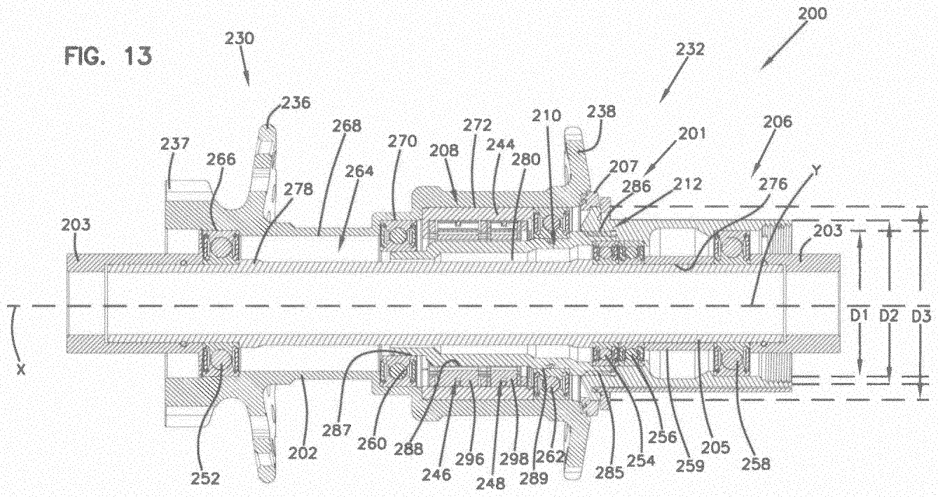

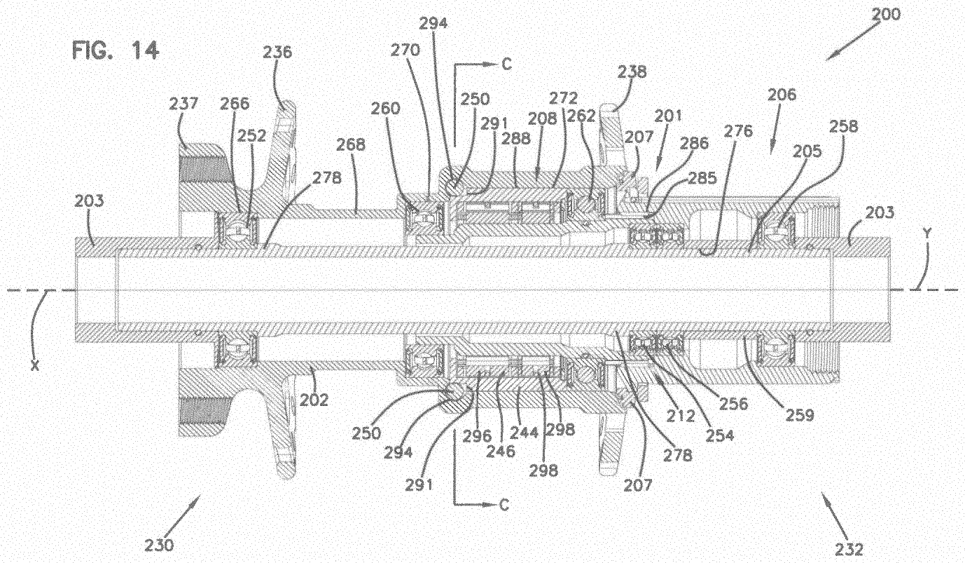

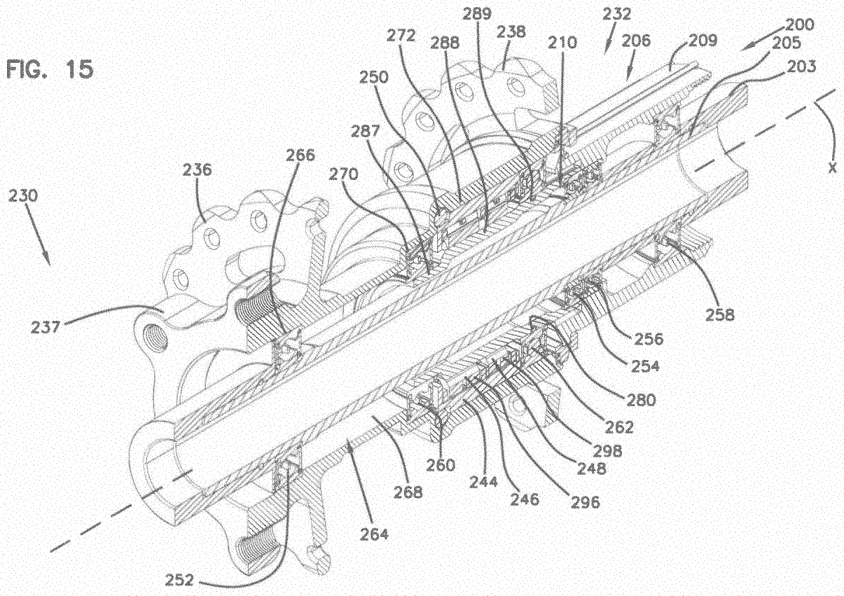

FIG. 13 shows a cross-sectional view along line A-A in FIG. 10. FIG. 14 shows a cross-sectional view along line B-B in FIG. 10. FIG. 15 shows a perspective view of the cross-sectional view of FIG. 14.

The hub body 202 includes an internal cavity 264 that extends from the first end 230 of the hub body 202 to the opposed second end 232 of the hub body 202. The internal cavity 264 of the hub body 202 defines a first internal cylindrical surface 266 defined by a first diameter D1 located at the first end 230 of the hub body 202. The internal cavity 264 of the hub body 202 defines a second internal cylindrical surface 268 adjacent the first internal cylindrical surface 266. The internal cavity 264 of the hub body 202 defines a third internal cylindrical surface 270 defined by a second diameter D2 located adjacent the second internal cylindrical surface 268. The internal cavity 264 of the hub body 202 defines a fourth internal cylindrical surface 272 defined by a third diameter D3 located adjacent the third internal cylindrical surface 270. The third diameter D3 is larger than the second diameter D2.

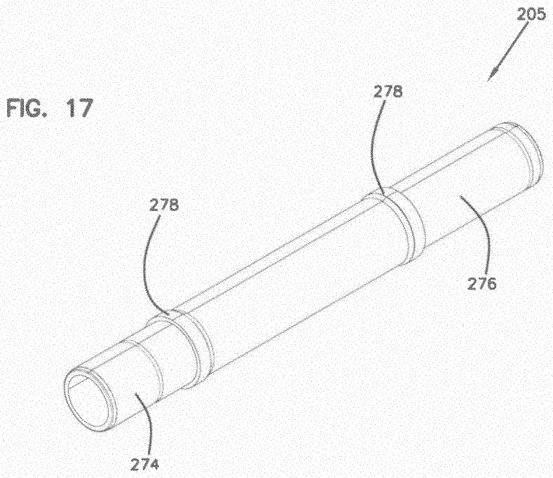

The axle 205 is substantially similar to the axle 105, described above. The axle 205 is also shown in FIGS. 17-19. The axle 205 includes a first bearing surface 274 and a second bearing surface 276, and extends through the internal cavity 264 of the hub body 202 in a coaxial arrangement with the longitudinal axis X. The first and second bearing surfaces 274, 276 have the same diameter D4 and D5. In some examples, the axle 205 can also include flanges 278 immediately adjacent the first and second bearing surfaces 274, 276. The first bearing surface 274 interfaces with the first axle bearing 252. In some examples, the first axle bearing 252 is a ball bearing. In some examples, the first axle bearing 252 is a bushing. The second bearing surface 276 interfaces with the second axle bearing 254, third axle bearing 256, and fourth axle bearing 258. In some examples, the axle 205 can be supported by more than four bearings. In some examples, the axle 205 is supported by less than four bearings.

The freehub drive system 201 is positioned within the second end 232 of the hub body 202. The freehub drive system 201 has a longitudinal rotational axis Y arranged coaxially with the longitudinal rotational axis X of the hub body 202. The freehub drive system 201 includes an annular opening 280 that is configured to receive the axle 205. The freehub drive system 201 includes the adapter shaft 210 and the freehub body 206 that are separably connected to one another.

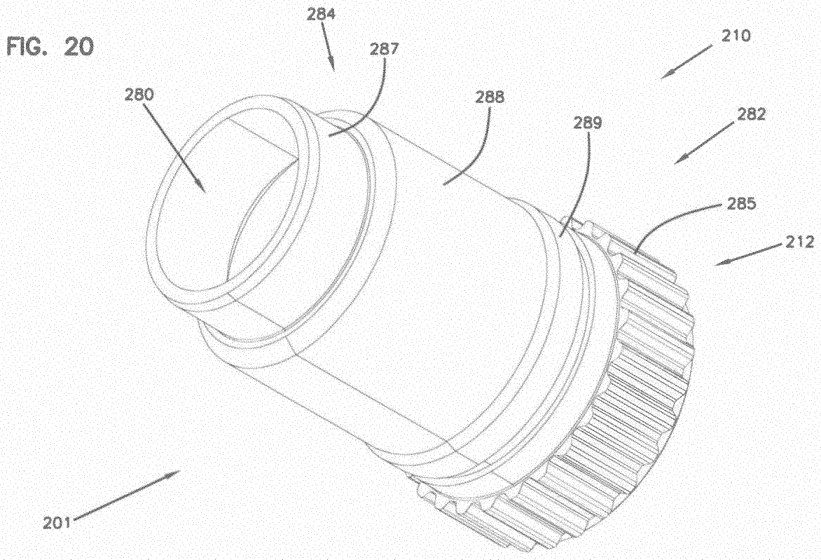

The adapter shaft 210 (driver) is substantially similar to the adapter shaft 110, described above. The adapter shaft 210 is also shown in FIGS. 20-24. The adapter shaft 210 includes a first portion 282 and a second portion 284. The first portion 282 of the adapter shaft 210 is configured to mate with the freehub body 206 at a mating interface 212. The mating interface 212 is substantially similar to the mating interface 112, described above.

The first portion 282 of the adapter shaft 210 includes a freehub body mating interface 285 that is configured to mate with a corresponding shaft mating interface 286 of the freehub body 206. In some examples, the mating interface 212, and therefore the freehub body mating interface 285 and shaft mating interface 286, include splines that mesh with one another to create the mating interface 212. The mating interface 212, the adapter shaft 210, and freehub body 206 rotate with one another to facilitate fixed rotation with one another around the longitudinal axis X. It is considered within the scope of the present disclosure that a variety of other mating surfaces having a variety of different configurations can be utilized to mate the adapter shaft 210 and the freehub body 206 to create the mating interface 212. In the depicted embodiment, the mating interface 212 is a slidable interface in that the freehub body mating interface 285 and shaft mating interface 286 can slide axially relative to each other. The slidable configuration enables easy disassembly of the adapter shaft 210 from the freehub body 206.

The first portion 282 of the adapter shaft 210 also includes the second axle bearing 254. In some examples, the second axle bearing 254 can be press-fit into the adapter shaft 210. When the hub 200 is assembled, the second axle bearing 254 is located between the second bearing surface 276 of the axle 205 and the annular opening 280 of the freehub drive system 201 to facilitate relative rotation between the axle 205 and the freehub drive system 201. In the depicted embodiment, the second axle bearing 254 is fit between the adapter shaft inner surface 300 opposite the freehub body mating interface 285. In the depicted embodiment, the second axle bearing 254 extends beyond the adapter shaft inner surface 300 in an axial direction. The portion of the second axle bearing 254 that extends beyond the adapter shaft inner surface 300 engages the inner surface 302 of the freehub body 206. This overlapping configuration provides additional structural stability to the hub 200. The freehub body mating interface 285 and the second axle bearing 254 at least partially radially overlap. In some examples, the second axle bearing 254 is a ball bearing. In some examples, the second axle bearing 254 is a bushing.

The second portion 284 of the adapter shaft 210 includes a stepped outer profile that has a first external cylindrical surface 287, a second external cylindrical surface 288, and a third external cylindrical surface 289. The first, second, and third external cylindrical surfaces 287, 288, 289 are substantially similar to the plurality of cylindrical outer surfaces 121, 123, 125 of the adapter shaft 110, described above. In some examples, the first external cylindrical surface 287, the second external cylindrical surface 288, and the third external cylindrical surface 289 each have constant diameters.

The first external cylindrical surface 287 is located at a first radial distance from the longitudinal rotational axis X. The first external cylindrical surface 287 radially overlaps the third internal cylindrical surface 270 of the hub body 202.

The second external cylindrical surface 288 is located at a second radial distance from the longitudinal rotational axis X. In some examples, the second radial distance is larger than the first radial distance. The second external cylindrical surface 288 is closer to the freehub body mating interface 285 than the first external cylindrical surface 287. In the depicted embodiment, the second external cylindrical surface 288 is harder than the surface of the internal cavity 264 of the hub body 202. The second external cylindrical surface 288 radially overlaps the fourth internal cylindrical surface 272 of the hub body 202. In some examples, the second external cylindrical surface 288 is a stainless steel sleeve connected to the adapter shaft 210. In some examples, the second external cylindrical surface 288 is monolithically formed with the adapter shaft 210.

The third external cylindrical surface 289 is located at a third radial distance from the longitudinal rotational axis X. In some examples, the third radial distance is larger than the second radial distance. In some examples, the third radial distance is equal to the second radial distance. The third external cylindrical surface 289 is closer to the freehub body mating interface 285 than the second external cylindrical surface 288. In some examples, the third external cylindrical surface 289 can include an O-ring,

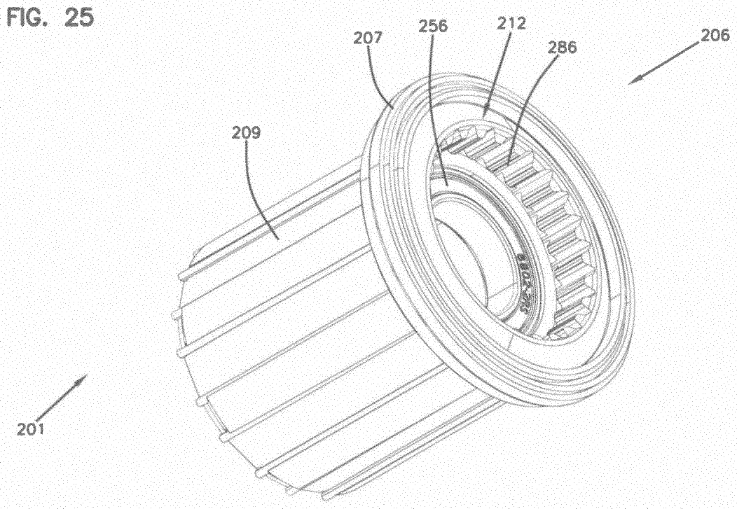

The freehub drive system 201 also includes the freehub body 206. In some examples, the freehub body 206 can be selectively mated with the adapter shaft 210 to allow for service, replacing, and easing manufacturing. The freehub body 206 is also shown in FIGS. 25-28. The freehub body 206 includes the outer surface 209, the shaft mating interface 286, the third axle bearing 256, and the fourth axle bearing 258.

The shaft mating interface 286 is configured to mate with the corresponding freehub body mating interface 285 of the adapter shaft 210. In some examples, the shaft mating interface 286 is a recess including a plurality of splines.

The third axle bearing 256 is located within the freehub body 206 between the second bearing surface 276 of the axle 205 and the annular opening 280 of the freehub drive system 201 to facilitate relative rotation between the axle 205 and the hub body 202. In some examples, the third axle bearing 256 is a ball bearing. In some examples, the third axle bearing 256 is a bushing. In some examples, the second axle bearing 254 and the third axle bearing 256 are identical. In some examples, the third axle bearing 256 is identical with at least one other axle bearing.

The fourth axle bearing 258 is located within the freehub body 206. In some examples, the freehub spacer 259 is positioned between the third axle bearing 256 and the fourth axle bearing 258. The fourth axle bearing 258 is located between the second bearing surface 276 of the axle 205 and the annular opening 280 of the freehub drive system 201 to facilitate relative rotation between the axle 205 and the hub body 202. In some examples, the fourth axle bearing 258 is a ball bearing. In some examples, the fourth axle bearing 258 is a bushing. In some examples, the first axle bearing 252 and the fourth axle bearing 258 are identical. In some examples, the fourth axle bearing 258 is identical with at least one other axle bearing.

The first freehub drive system bearing 260 is located between the first external cylindrical surface 287 of the adapter shaft 210 of the freehub drive system 201 and the third internal cylindrical surface 270 of the hub body 202 to facilitate relative rotation between the freehub drive system 201 and the hub body 202. In some examples, the first freehub drive system bearing 260 is a ball bearing. In some examples, the first freehub drive system bearing 260 is a bushing.

The second freehub drive system bearing 262 is located between the third external cylindrical surface 289 of the adapter shaft 210 of the freehub drive system 201 and the fourth internal cylindrical surface 272 of the hub body 202 to facilitate relative rotation between the freehub drive system 201 and the hub body 202.

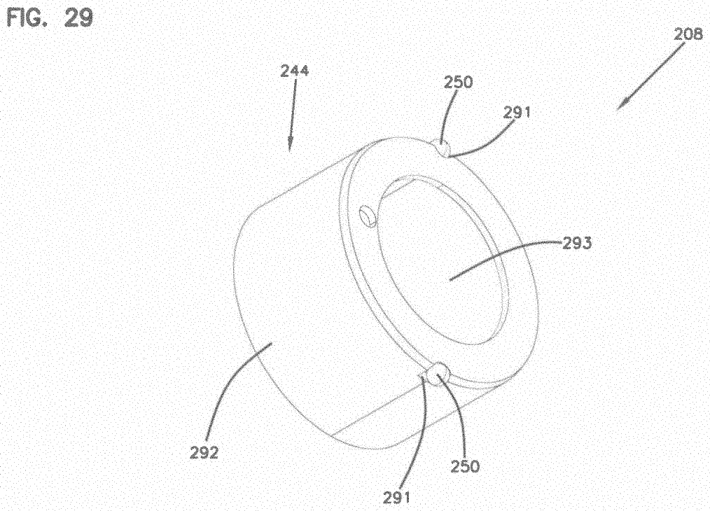

The sprag clutch 208 is substantially similar to the sprag clutch 108, as described above. The sprag sleeve 244 of the sprag clutch 208 is press fit into the fourth internal cylindrical surface 272 of the hub body 202 in radial alignment with a portion of the second external cylindrical surface 288 of the adapter shaft 210 of the freehub drive system 201. The sprag sleeve 244 is also shown in FIGS. 29-32. In some examples, the sprag sleeve 244 includes a pair of anti-rotation recesses 291 at an outer surface 292 of the sprag sleeve 244. The sprag sleeve 244 has a cylindrical internal surface 293 that is harder than the surface of the internal cavity 264 of the hub body 202. In some examples, the sprag clutch 208 includes more than one sprag sleeve 244.

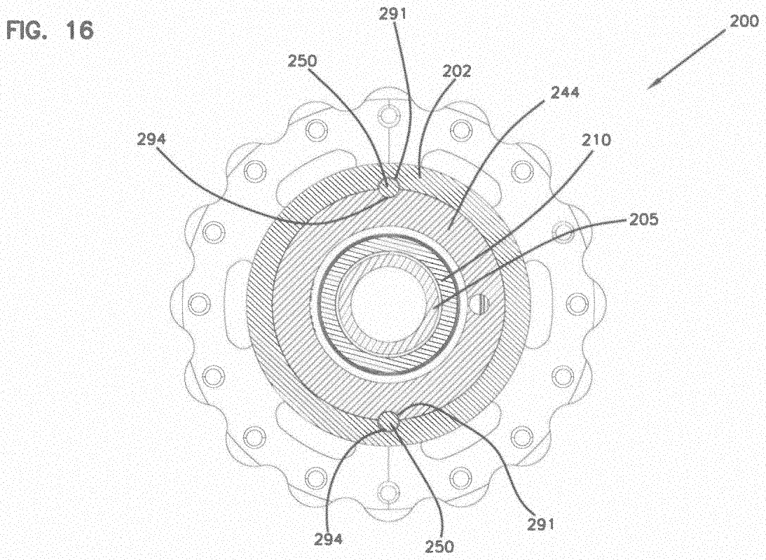

The pair of sprag sleeve anti-rotation elements 250 interface with the sprag sleeve 244 and the internal cavity 264 of the hub body 202 to reduce relative rotation therebetween. The anti-rotation elements 250 are positioned within the anti-rotation recesses 291 of the sprag sleeve 244 and also within the anti-rotation recesses 294 defined in the fourth internal cylindrical surface 272 of the hub body 202, as can be seen in FIG. 13. Further, FIG. 16 shows a lateral cross section of the hub 200 along the line C-C in FIG. 13. The anti-rotation elements 250 are also shown in FIGS. 29-32. Other like elements can be used to prevent relative rotation between the sprag sleeve 244 and the hub body 202.

In the depicted embodiment, the sprag sleeve anti-rotation elements 250 are at least partially spherical. In the depicted embodiment, the sprag sleeve anti-rotation elements 250 are steel spheres. In the depicted embodiment, the anti-rotation recesses 291 are formed by drilling at an angle into the second external cylindrical surface 288. The stepped body portion 240 of the hub body 202 also includes a rib 304. The rib 304 provides extra strength to support the force that the anti-rotation elements 250 can impart on the hub body 202 during use. When the hub 200 is assembled, the anti-rotation elements 250 are placed into the anti-rotation recesses 291, and the hub 200 is orientated with the first end 230 down to enable gravity to keep the anti-rotation elements 250 in place until the sprag sleeve 244 is in place.

In alternative examples, the sprag sleeve anti-rotation elements 250 are an integral part of the sprag sleeve 244. In some examples, the sprag sleeve anti-rotation elements 250 are an integral part of the internal cavity 264 of the hub body 202. In some examples, the sprag sleeve anti-rotation elements 250 are metal spheres. In some examples, the sprag sleeve anti-rotation elements 250 are at least partially cylindrical. In some examples, the sprag sleeve anti-rotation elements 250 are at least partially rectangular.

In the depicted embodiment, the sprag clutch 208 further includes the first sprag cage 246 that has a plurality of sprags 296 that are tension-biased directly against the second external cylindrical surface 288 of the adapter shaft 210 of the freehub drive system 201 and radially aligned with the sprag sleeve 244. The sprag clutch 208 can also include the second sprag cage 248 adjacent the first sprag cage 246. The second sprag cage 248 is substantially similar to the first sprag cage 246 and can include a plurality of sprags 296 that are tension-biased directly against the second external cylindrical surface 288 of the adapter shaft 210 of the freehub drive system 201 and radially aligned with the sprag sleeve 244. In some examples, the second sprag cage 248 is smaller than the first sprag cage 246. In some examples, the second sprag cage 248 is equal in size to the first sprag cage 246. In some examples, the second sprag cage 248 is larger than the first sprag cage 246. In some examples, the sprag clutch 208 can include more than two sprag cages.

Due to the configuration of the axle bearings 252, 254, 256, 258 and the hub body 202, the hub 200 can be converted to accommodate a variety of different lengths and types of axles. For example, a single hub body 202 can accommodate both quick release and thru-axles to secure the hub 200 to a bicycle. Additionally, a single hub body 202 can accommodate a variety of different hub spacing standards of bicycles. This allows for a single hub body 202, and the components therein, to be manufactured and assembled for a variety of different applications. This not only makes manufacturing more efficient, but it also allows the hub body 202 to be retrofitted to accommodate a variety of different hub spacing and securing standards.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

We claim:

1. A freewheel hub comprising:
a main hub body defining a longitudinal rotational axis, the hub body including an internal cavity that extends from a first end portion of the main hub body to an opposed second end portion of the main hub body;
a driver including a first end portion, a second end portion, and an internal cavity that extends from the first end portion to the second end portion, the first end portion including a freehub body mating interface, the second end portion being coaxially positioned within the second end portion of the main hub body;
a sprag assembly located between the second end portion of the driver and the internal cavity of the main hub body, the sprag assembly configured to enable the driver to drive the rotation of the main hub body and also enable the main hub body to rotate independent of the driver; and
a freehub body including a first end portion, a second end portion, and internal cavity that extends from the first end portion to the second end portion, the first end portion of the freehub body including a driver mating interface configured to mate with a corresponding freehub body mating interface of the driver to prevent relative rotation between the driver and the freehub body.

2. The freewheel hub of claim 1, wherein the freehub body mating interface and the driver mating interface have an intermeshed splined configuration.

3. The freewheel hub of claim 1, wherein the freehub body mating interface and the driver mating interface are slidably engaged in the axial direction.

4. The freewheel hub of claim 1, further comprising a bearing that is engaged with the internal cavity of the driver and is in at least partial radial alignment with the freehub body mating interface of the driver.

5. The freewheel hub of claim 4, wherein the bearing that is in at least partial radial alignment with the freehub body mating interface also extends beyond a distal end of the freehub body mating interface and is engaged with an internal cavity of the freehub body.

6. The freewheel hub of claim 1, further comprising a sprag sleeve press-fit into the internal cavity of the main hub body, the sprag sleeve including at least one recess for receiving a first portion of an anti-rotation element, wherein the internal cavity of the main hub body includes at least one recess for receiving a second portion of the anti-rotation element.

7. The freewheel hub of claim 6, wherein the main hub body includes an annular rib in radial alignment with the at least one recess for receiving the second portion of the anti-rotation element in the internal cavity of the main hub body.

8. The freewheel hub of claim 6, wherein the sprag sleeve includes at least two recesses for receiving a first portion of the anti-rotation element, wherein the internal cavity of the main hub body includes at least two recesses for receiving a second portion of the anti-rotation element.

9. The freewheel hub of claim 6, further comprising the anti-rotation element, wherein the anti-rotation element is a spherical steel ball.

10. The freewheel hub of claim 1, wherein the main hub body includes a stepped outer profile, the first end portion including a constant diameter portion, the second end portion including a constant diameter portion, wherein the constant diameter portion of the second end has a diameter that is larger than a diameter of the constant diameter portion of the first end, and wherein the second end portion of the driver extends through the constant diameter portion of the second end portion of the main hub body and does not extend into the constant diameter portion of the first end portion of the main hub body.

11. The freewheel hub of claim 1, wherein the sprag assembly includes at least one sprag cage positioned between the second end portion of the driver and the internal cavity of the main hub body, and includes bearings on either side of the sprag cage located between the second end portion of the driver and the internal cavity of the main hub body.

12. The freewheel hub of claim 1, further comprising a through axle that extends from beyond the first end portion of the main hub body through the main hub body, the driver, and freehub body to beyond the second end portion of the freehub body.

13. The freewheel hub of claim 12, further comprising a bearing assembly that interfaces between the through axle and the main hub body, driver, and freehub body, the bearing assembly including at least one bearing that interfaces between the first end portion of the main hub body and the through axle, and at least one bearing that interfaces between the second end portion of the freehub body and the through axle.

14. The freewheel hub of claim 13, wherein the bearing assembly that interfaces between the through axle and the main hub body, driver and freehub body further comprises at least one bearing that interfaces between the first end portion of the freehub body and the through axle.

15. The freewheel hub of claim 4, wherein the bearing that is in at least partial radial alignment with the freehub body mating interface also engages a through axle.
